(19) United States
(12) Patent Application Publication
(10) Pub. No.: US 2019/0106130 A1
(43) Pub. Date: Apr. 11, 2019

(54) ENGINE RECOVERY SYSTEM FOR POWER SYSTEM

(71) Applicant: Progress Rail Locomotive Inc., LaGrange, IL (US)

(72) Inventors: Reddy Pocha Siva Sankara, Naperville, IL (US); Sudarshan Loya, Naperville, IL (US); Michael B. Goetzke, Orland Park, IL (US); Keith Moravec, Downers Grove, IL (US); Edward J. Gawel, JR., Woodridge, IL (US); Scott Michael Branka, Campton Hills, IL (US)

(73) Assignee: Progress Rail Locomotive Inc., LaGrange, IL (US)

(21) Appl. No.: 15/725,334

(22) Filed: Oct. 5, 2017

(51) Int. Cl. B61D 43/00; F02B 37/18; F01D 15/08; F01D 15/10; B61C 5/04

(52) U.S. Cl. CPC B61D 43/00; F02B 37/183; F05D 2220/40; F01D 15/10; B61C 5/04; F01D 15/08

(57) ABSTRACT

An energy recovery system for a power system is disclosed. The power system includes an engine, a generator driven by the engine, an electrical bus configured to receive electrical power from the generator, an exhaust conduit configured to receive exhaust gases from the engine, and a turbocharger coupled to the exhaust conduit. The energy recovery system includes a bypass conduit, a turbo-generator, and a synchronizer. The bypass conduit is coupled to the exhaust conduit, and facilitates a portion of exhaust gases from the exhaust conduit to bypass the turbocharger. The turbo-generator is coupled to the bypass conduit, and is driven by the portion of exhaust gases bypassing the turbocharger. Further, the synchronizer modulates one or more parameters of electrical power received from the turbo-generator based on one or more parameters of electrical power present on the electrical bus. The synchronizer transmits modulated electrical power to the electrical bus.

### TECHNICAL FIELD

The present disclosure relates to a power system. More particularly, the present disclosure relates to an energy recovery system for the power system of a locomotive.

### BACKGROUND

Internal combustion engines such as diesel engines generally include turbochargers to utilize energy of exhaust gases to provide compressed air to the engine to boost engine power and efficiency. Turbochargers are generally designed or selected for use with the engine to meet demands at the lower and mid speed and power ranges of the engine. However, when the engines are operated at the rated and near rated conditions, substantial amount of exhaust gases may be bypassed from the turbochargers and discharged to the atmosphere. This leads to wastage of exhaust energy and impact fuel economy of the engines.

U.S. Pat. No. 8,813,494 relates to an engine system having a turbocharger, a bypass path facilitating a portion of exhaust gases to bypass the turbocharger, and a turbo-compounding unit driven by the exhaust gases received via the bypass path, and having a turbine and a generator driven by the turbine to generate electrical power. The electrical power generated by the turbo-compounding unit is stored into a battery. The electrical power stored in the battery is utilized to power one or more electrical components such as traction motors.

### SUMMARY OF THE INVENTION

In one aspect, the disclosure relates to an energy recovery system for a power system. The power system includes an engine, a generator driven by the engine to produce electrical power, an electrical bus configured to receive electrical power from the generator, and an exhaust conduit configured to receive exhaust gases discharged from the engine. The power system further includes a turbocharger coupled to the exhaust conduit to receive exhaust gases from the engine. The turbocharger is configured to provide compressed air to the engine. The energy recovery system includes a bypass conduit, a turbo-generator, and a synchronizer. The bypass conduit is coupled to the exhaust conduit upstream of the turbocharger, and facilitates a portion of exhaust gases from the exhaust conduit to bypass the turbocharger. The turbo-generator is coupled to the bypass conduit, and is driven by the portion of exhaust gases bypassing the turbocharger to generate electrical power. Further, the synchronizer is electrically coupled to the turbo-generator and the electrical bus. The synchronizer is configured to modulate one or more parameters of electrical power received from the turbo-generator based on one or more parameters of electrical power present on the electrical bus. The synchronizer transmits modulated electrical power to the electrical bus.

In another aspect, the disclosure relates to a power system including an engine, a generator, an electrical bus, an exhaust conduit, a turbocharger, a bypass conduit, a turbo-generator, and a synchronizer. The generator is driven by the engine to produce electrical power. The electrical bus is configured to receive electrical power from the generator, and provides electrical power to one or more loads. The exhaust conduit is configured to receive exhaust gases discharged from the engine. The turbocharger is coupled to the exhaust conduit to receive exhaust gases from the engine, and is configured to provide compressed air to the engine. The bypass conduit is coupled to the exhaust conduit upstream of the turbocharger, and facilitates a portion of exhaust gases from the exhaust conduit to bypass the turbocharger. The turbo-generator is coupled to the bypass conduit, and is driven by the portion of exhaust gases bypassing the turbocharger to generate electrical power. The synchronizer is electrically coupled to the turbo-generator and the electrical bus. The synchronizer is configured to modulate one or more parameters of electrical power received from the turbo-generator based on one or more parameters of electrical power present on the electrical bus. Further, the synchronizer transmits modulated electrical power to the electrical bus.

In yet another aspect, the disclosure relates to a locomotive. The locomotive includes an engine, a generator driven by the engine to produce electrical power, an electrical bus electrical bus configured to receive electrical power from the generator, and one or more loads configured to receive electrical power from the electrical bus. The locomotive further includes an exhaust conduit, a turbocharger, a bypass conduit, a turbo-generator, and a synchronizer. The exhaust conduit is configured to receive exhaust gases discharged from the engine. The turbocharger is coupled to the exhaust conduit to receive exhaust gases from the engine, and is configured to provide compressed air to the engine. The bypass conduit is coupled to the exhaust conduit upstream of the turbocharger. The bypass conduit facilitates a portion of exhaust gases from the exhaust conduit to bypass the turbocharger. The turbo-generator is coupled to the bypass conduit, and is driven by the portion of exhaust gases bypassing the turbocharger to generate electrical power. The synchronizer is electrically coupled to the turbo-generator and the electrical bus. The synchronizer is configured to modulate one or more parameters of electrical power received from the turbo-generator based on one or more parameters of electrical power present on the electrical bus. Further, the synchronizer transmits modulated electrical power to the electrical bus.

### BRIEF DESCRIPTION OF THE DRAWINGS

FIG. 1 illustrates a locomotive having a power system, in accordance with an embodiment of the present disclosure;

FIG. 2 illustrates a schematic view of the power system having a generator as a traction alternator of the locomotive, and an energy recovery system, in accordance with an embodiment of the present disclosure; and

FIG. 3 illustrates a schematic view of the power system having the generator as a companion alternator of the locomotive, and the energy recovery system, in accordance with an embodiment of the present disclosure.

### DETAILED DESCRIPTION

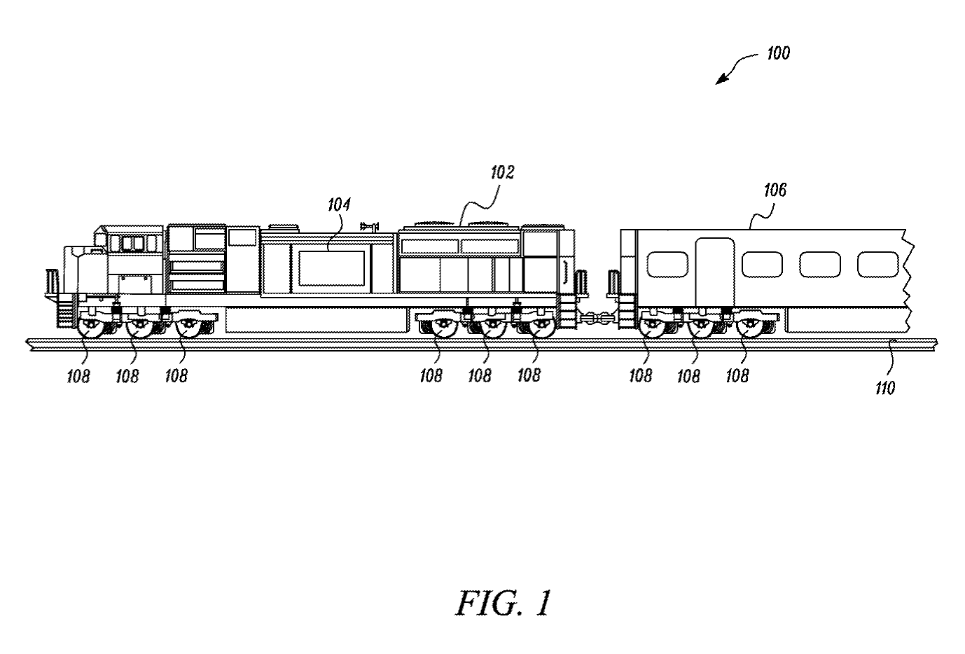

Referring to FIG. 1, a machine 100 is disclosed. The machine 100 may be a locomotive system. The machine 100 includes a locomotive 102 with a power system 104 mounted on the locomotive 102. The machine 100 also includes one or more railcars 106 (only a portion of one railcar 106 is shown in FIG. 1) that are coupled with the locomotive 102. The railcars 106 may be coupled and arranged sequentially with the locomotive 102. The power system 104 is configured to generate power needed to operate, for example, propel the machine 100. A number of wheels 108 are positioned throughout a length of the machine 100 in a known manner. The wheels 108 engage tracks 110 of an associated railroad, supporting and facilitating traversal of the machine 100 over the railroad.

Although the above discussion, aspects of the present disclosure may be applicable to various other machines and environments. Non-limiting examples of the machines 100, for both commercial and industrial purposes, may include diesel electric locomotives, diesel mechanical locomotives, steam locomotives, mining trucks, on-highway trucks, off-highway trucks, loaders, excavators, dozers, motor graders, tractors, trucks, backhoes, agricultural equipment, material handling equipment, marine vessels, and other machines that operate in a work environment. It is to be understood that the locomotive system is shown primarily for illustrative purposes so as to assist in disclosing features and various embodiments of the present disclosure.

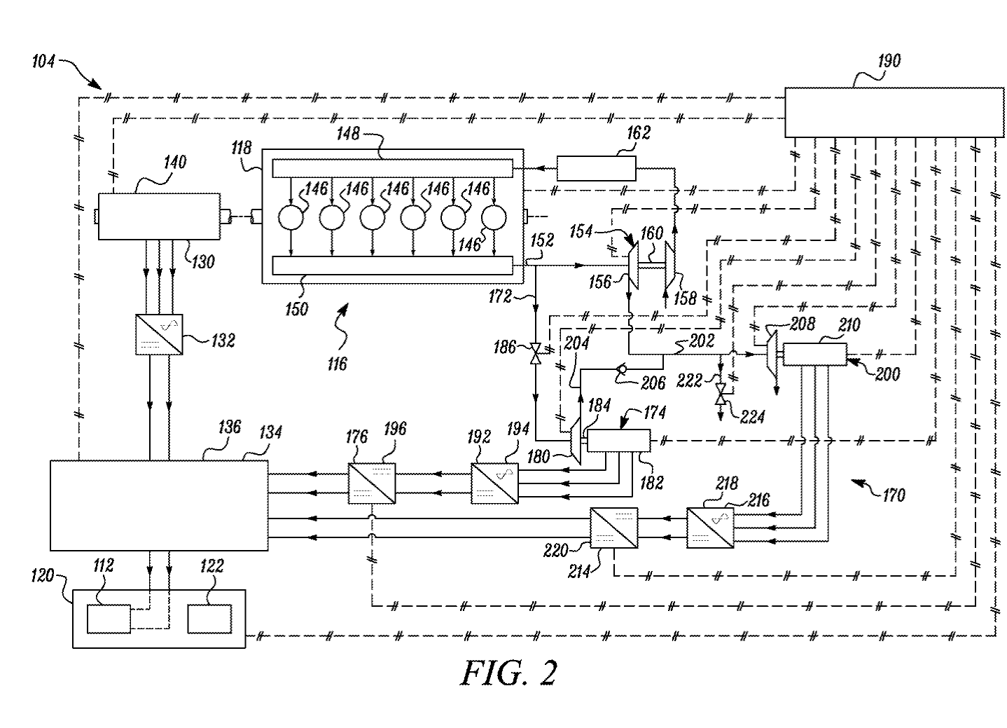

Referring to FIGS. 1 and 2, the locomotive 102 further includes one or more traction motors 112 that is driven by the power system 104. The traction motors 112 is configured to power the wheels 108 to move the machine 100. Further, the traction motors 112 may act as a generator during a braking of the locomotive 102. Therefore, the traction motors 112 may generate electrical power during the braking of the locomotive 102.

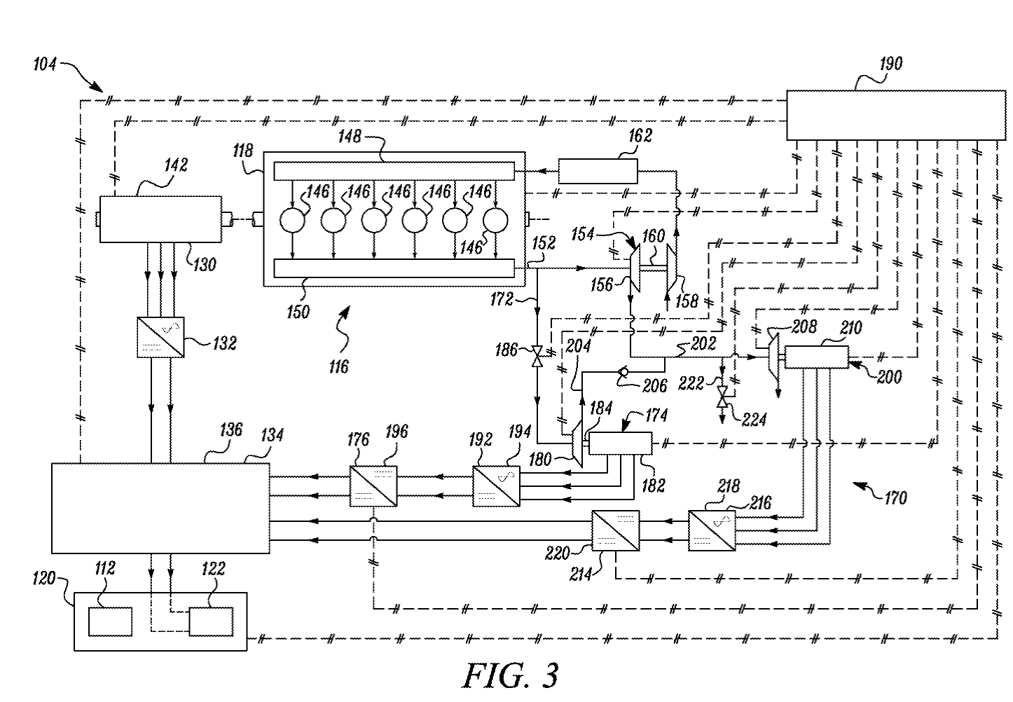

Referring to FIG. 2 and FIG. 3, the power system 104 is shown. The power system 104 may be configured to generate power and provide power to one or more loads 120 of the locomotive 102 and/or the railcars 106. The one or more loads 120 may include propulsion loads and/or non-propulsion based loads. For example, the one or more loads 120 may include one or more auxiliary loads 122 of the locomotive 102 and/or the railcars 106. The one or more loads 120 may also include the one or more traction motors 112 of the locomotive 102. The power system 104 includes an engine system 116 having an internal combustion engine 118 (simply, engine 118) that facilitates a locomotion of the machine 100 and an operation of the various other systems of the machine 100.

The engine 118 represents one of the commonly applied power generation units in the machines 100 such as the locomotive systems. The engine 118 may be housed within an engine compartment of an engine assembly of the locomotive 102, as well known. The engine 118 may be powered by a gaseous fuel, such as liquefied natural gas (LNG), propane gas, hydrogen gas, or any other suitable gaseous fuel, singularly or in combination with each other. Alternatively, the engine 118 may be based on a dual-fueled engine system, a diesel-fueled engine system, or a spark ignited engine system. The engine 118 may embody a V-type, an in-line, or any other configuration, as is conventionally known. The engine 118 may be a multi-cylinder engine, although aspects of the present disclosure are applicable to engines with a single cylinder as well. Further, the engine 118 may be one of a two-stroke engine, a four-stroke engine, or a six-stroke engine. Although these configurations are disclosed, aspects of the present disclosure need not be limited to any particular engine type.

The power system 104 may include various electrical and electronic units, such as logic devices, inverters, rectifiers, etc., that facilitate an operation of the power system 104. In detail, the power system 104 further includes a generator 130, one or more rectifiers 132, and an electrical bus 134. The generator 130 operatively coupled to the engine 118, and is driven by the engine 118 to produce electrical power. The generator 130 is configured to convert mechanical power generated by the engine 118 into electrical power in the form of alternating current (AC). At the output of the generator 130, the one or more rectifiers 132 may convert AC electrical power to direct current (DC) electrical power. DC electrical power is conveyed on to the electrical bus 134, for example a DC link 136. Therefore, the electrical bus 134 receives electrical power from the generator 130 and provides electrical power to one or more loads 120 of the locomotive 102 or the machine 100. The power system 104 may include one or more electrical systems (not shown) to facilitate a power delivery from the electrical bus 134 in an acceptable form to the one or more loads 120. The one or more electrical systems may include one or more rectifiers, auxiliary inverters, contactors, transformers, auxiliary power converters, switches, etc., that may facilitate electrical power delivery from the electrical bus 134 in an acceptable form to the one or more loads 120.

In an embodiment, as shown in FIG. 2, the generator 130 is a traction alternator 140, and the electrical bus 134 is configured to provide electrical power to the traction motors 112 of the locomotive 102. The electrical bus 134, additionally or optionally, may provide power to the auxiliary loads 122. In an embodiment, as shown in FIG. 3, the generator 130 is a companion alternator 142 of the locomotive 102, and the electrical bus 134 is configured to provide electrical power to the auxiliary loads 122. In such an embodiment, the power system 104 may also include a traction alternator, separate and different from the companion alternator 142, and associated electrical bus to provide power to the traction motors 112.

As shown in FIGS. 2 and 3, the engine 118 includes one or more cylinders 146. As shown in FIGS. 2 and 3, the engine 118 is a multi-cylinder engine (six cylinders are shown), although aspects of the present disclosure are also applicable to engines with a single cylinder as well. The engine 118 may include an intake manifold 148 connected with the cylinders 146 to provide air to the cylinders 146 for combustion. The engine 118 also includes an exhaust manifold 150 connected with the cylinders 146 to receive exhaust gases discharged by the cylinders 146. The engine system 116 further includes an exhaust conduit 152 configured to receive exhaust gases discharged from the engine 118, and a turbocharger 154 coupled to the exhaust conduit 152 to receive the exhaust gases from the engine 118. In an implementation, exhaust gases from the exhaust manifold 150 flow to the turbocharger 154 through the exhaust conduit 152. For this purpose, the exhaust conduit 152 fluidly couples the engine 118 to the turbocharger 154.

The turbocharger 154 includes a first turbine 156 and a compressor 158 operatively coupled to the first turbine 156 via a shaft 160. The first turbine 156 is driven by exhaust gases received from the exhaust conduit 152 to rotate the compressor 158 and compress an air received from an ambient. The air compressed and discharged by the compressor 158 may be directed to the intake manifold 148 and subsequently to the cylinders 146. In this manner, the turbocharger 154 provides compressed air to the engine 118. Further, it may be appreciated that engine system 116 may also include one or more additional turbochargers arranged in series relative to the turbocharger 154. In such a case, the additional turbochargers may further compress the compressed air received from the turbocharger 154 before directing the compressed air to the engine 118. The additional turbochargers may be driven by the exhausts gases discharged by the first turbine 156 of the turbocharger 154. The engine system 116 may also include one or more after-coolers, for example an after-cooler 162 to cool the compressed air received from the turbocharger 154, before delivering the compressed air to the engine 118. As shown, the after-cooler 162 may be arranged to cool the compressed air being delivered to the intake manifold 148.

Again referring to FIGS. 2 and 3, the power system 104 further include an energy recovery system 170 for recovering energy from exhaust gases discharged by the engine 118 and flowing through the exhaust conduit 152. The energy recovery system 170 includes a bypass conduit 172, a turbo-generator 174 (herein after referred to as a first turbo-generator 174), and a synchronizer 176 (herein after referred to as a first synchronizer 176). The bypass conduit 172 is coupled to the exhaust conduit 152 to facilitate a portion of exhaust gases flowing into the exhaust conduit 152 to bypass the turbocharger 154. The bypass conduit 172 may be coupled to the exhaust conduit 152 at a location upstream of the turbocharger 154 and downstream of the exhaust manifold 150. The bypass conduit 172 is further coupled to the first turbo-generator 174 to provide exhaust gases bypassed from the turbocharger 154 to the first turbo-generator 174.

The first turbo-generator 174 is driven by the portion of exhaust gases bypassing the turbocharger 154 to generate electrical power. For so doing, the first turbo-generator 174 may include a second turbine 180 and a second generator 182 operatively connected to the second turbine 180 by a shaft 184. The second turbine 180 is fluidly coupled to the bypass conduit 172, and is driven by the portion of the exhaust gases received via the bypass conduit 172. The second turbine 180 in turn drives the second generator 182 to produce electrical power. The first turbo-generator 174 generates/produces electrical power in the form of alternating current (AC). It may be appreciated that a magnitude of electrical power produced by the second generator 182, and hence the first turbo-generator 174 may depend on a speed of rotation of the second turbine 180. The speed of rotation of the second turbine 180 may depend on one or more of a pressure, a temperature, an amount of exhaust gases received by the second turbine 180 via the bypass conduit 172.

The energy recovery system 170 may include a bypass valve 186 configured to control an amount of exhaust gases flowing through the bypass conduit 172 directed to the second turbine 180, and hence to the first turbo-generator 174. In an embodiment, as shown in FIG. 2 and FIG. 3, the bypass valve 186 may be disposed on the bypass conduit 172. In certain implementations, the bypass valve 186 may be disposed at a junction of the bypass conduit 172 and the exhaust conduit 152. In such a case, the bypass valve 186 may be a 3-way valve. The bypass valve 186 may be controlled based on one or more engine parameters such as an engine load, an engine power, an engine speed etc. Further, the bypass valve 186 may be controlled based on a magnitude of electrical power generated by the first turbo-generator 174 and/or a maximum electrical power generating capacity of the first turbo-generator 174. The second generator 182 and hence the first turbo-generator 174 is electrically coupled to the first synchronizer 176, and provides electrical power to the first synchronizer 176.

The first synchronizer 176 modulates one or more parameters of electrical power received from the first turbo-generator 174. The one or more parameters of electrical power received from the first turbo-generator 174 may include a voltage, a current, a frequency, a phase angle etc. The first synchronizer 176 modulates the one or more parameters of electrical power received from the first turbo-generator 174 based on one or more parameters of electrical power present of the electrical bus 134. The one or more parameters of electrical power present of the electrical bus 134 may include a voltage, a current a frequency, a phase angle, etc. After modulating the one or more parameters of electrical power received from the first turbo-generator 174, the first synchronizer 176 transmits modulated electrical power to the electrical bus 134 that is electrically coupled to the first synchronizer 176.

In an exemplary embodiment, the first synchronizer 176 may modulate a voltage of electrical power received from first turbo-generator 174 to a level/value equal to a voltage of electrical power present of the electrical bus 134. For example, the voltage of electrical power received from the first turbo-generator 174 may be 100 kilovolt (kv), and the voltage of electrical power present on the electrical bus 134 is 150 kv. In such a case, the first synchronizer 176 may modulate the voltage of electrical power received from the first turbo-generator 174 to a value equal to 150 kv before transmitting electrical power to the electrical bus 134. In other implementations, the first synchronizer 176 may modulate a frequency of electrical power received from first turbo-generator 174 to a level/value equal to a frequency of electrical power present of the electrical bus 134. In some other implementations, the first synchronizer 176 may modulate both voltage and frequency of electrical power received from first turbo-generator 174 to a level/value equal to a voltage and a frequency of electrical power present of the electrical bus 134.

To enable the modulation, by the first synchronizer 176, of the one or more parameters of electrical power received from the first turbo-generator 174, the power system 104 may include a controller 190 that may determine/check values corresponding to the one or more parameters of electrical power existing/present on the electrical bus 134. In an embodiment, the controller 190 may control the first synchronizer 176 to modulate the one or more parameters of electrical power received from first turbo-generator 174 to a level/value equal to the one or more parameters of electrical power present of the electrical bus 134. Alternatively, the first synchronizer 176 may modulate the one or more parameters of electrical power received from the first turbo-generator 174 based on the information received from the controller 190. In some implementations, the first synchronizer 176 may determine the one or more parameters of electrical power existing on the electrical bus 134.

In some implementations, the first synchronizer 176 may receive electrical power as direct current (DC) electrical power. To this end. AC electrical power generated by the first turbo-generator 174 is converted to DC electrical power before being received by the first synchronizer 176. To this end, as shown in FIG. 2 and FIG. 3, the energy recovery system 170 may include a converter 192 (hereinafter referred to as a first converter 192) electrically connecting the first turbo-generator 174 to the first synchronizer 176. The first converter 192 is configured to receive electrical power from the first turbo-generator 174, converts electrical power from alternating current (AC) electrical power to DC electrical power, and transfers/transmits DC electrical power to the first synchronizer 176. Thus, the first converter 192 may be an AC-DC converter 194 that is configured to convert AC electrical power received from the first turbo-generator 174 to DC electrical power. In such a case, the first synchronizer 176 may be a DC-DC converter 196 that modulates/changes a voltage of electrical power received from the first converter 192, and hence received from the first turbo-generator 174, and transfers electrical power to the electrical bus 134. The DC-DC converter modulates/changes the voltage of electrical power received from the first converter 192, and hence received from the first turbo-generator 174 based on a voltage of electrical power present on the electrical bus 134.

Additionally, or optionally, the energy recovery system 170 may include a second turbo-generator 200 fluidly coupled to the turbocharger 154 and the first turbo-generator 174. The second turbo-generator 200 is driven by exhaust gases discharged by both the turbocharger 154 and the first turbo-generator 174 to produce electrical power. The energy recovery system 170 may include a first conduit 202 fluidly coupling the turbocharger 154 to the second turbo-generator 200 to facilitate a flow of exhaust gases discharged by the turbocharger 154 to the second turbo-generator 200. Further, exhaust gases discharged by the first turbo-generator 174 may also enter the first conduit 202 downstream of the turbocharger 154 and upstream of the second turbo-generator 200. To this end, the energy recovery system 170 may include a second conduit 204 facilitating a flow of exhaust gases discharged by the first turbo-generator 174 to the first conduit 202, and hence to the second turbo-generator 200. In an embodiment, a check valve 206 may be positioned in the second conduit 204 to restrict a flow of exhaust gases from the first conduit 202 to the first turbo-generator 174.

The second turbo-generator 200 includes a third turbine 208 and a third generator 210. The third turbine 208 is driven by exhaust gasses received from the first conduit 202 to drive the third generator 210 to produce electric power. The third generator 210 is coupled to the third turbine 208 via a shaft. The second turbo-generator 200 generates/produces electrical power in the form of alternating current (AC). Electrical power generated by the second turbo-generator 200 is transmitted to the electrical bus 134. The energy recovery system 170 may include a second synchronizer 214 to facilitate a transmission/transfer of electrical power generated by the second turbo-generator 200 to the electrical bus 134. Similar to the first synchronizer 176, the second synchronizer 214 modulates one or more parameters of electrical power received from the second turbo-generator 200 before transferring on the electrical bus 134. The one or more parameters of electrical power received from the second turbo-generator 200 may include a voltage, a current, a frequency, a phase angle, etc.

The second synchronizer 214 modulates one or more parameters of electrical power received from the second turbo-generator 200 based on the one or more parameters of electric power present on the electrical bus 134. The one or more parameters of electrical power present of the electrical bus 134 may include a voltage, a current, a frequency, a phase angle, etc. After modulating the one or more parameters of electrical power received from the second turbo-generator 200, the second synchronizer 214 transmits/transfers modulated electrical power to the electrical bus 134. In an exemplary embodiment, the second synchronizer 214 may modulate a voltage of electrical power received from second turbo-generator 200 to a level/value equal to a voltage of electrical power present on the electrical bus 134. For example, the voltage of electrical power received, by the second synchronizer 214, from the second turbo-generator 200 may be 25 kilovolt (kv), and a voltage of electrical power present on the electrical bus 134 is 150 kv. In such a case, the second synchronizer 214 modulates the voltage of electrical power received from the second turbo-generator 200 to the value equal to 150 kv before transmitting electrical power to the electrical bus 134. In other implementations, the second synchronizer 214 may modulate a frequency of electrical power received from second turbo-generator 200 to a level/value equal to a frequency of electrical power present of the electrical bus 134. In some other implementations, the second synchronizer 214 may modulate both voltage and frequency of electrical power received from second turbo-generator 200 to a level/value equal to voltage and frequency of electrical power present of the electrical bus 134.

To enable the modulation, by the second synchronizer 214, of the one or more parameters of electrical power received from the second turbo-generator 200, the controller 190 may determine/check values corresponding to the one or more parameters of electrical power existing on the electrical bus 134. In an embodiment, the controller 190 may control the second synchronizer 214 to modulate the one or more parameters of electrical power received from second turbo-generator 200 to a level/value equal to the one or more parameters of electrical power present of the electrical bus 134. Alternatively, the second synchronizer 214 may modulate the one or more parameters of electrical power received from the second turbo-generator 200 based on the information received from the controller 190. In some implementations, the second synchronizer 214 may determine the one or more parameters of electrical power existing of the electrical bus 134.

In some implementations, the second synchronizer 214 may receive electrical power as direct current (DC) electrical power. To this end, AC electrical power generated by the second turbo-generator 200 is converted to DC electrical power before being received by the second synchronizer 214. To this end, as shown in FIG. 2 and FIG. 3, the energy recovery system 170 may include a second converter 216 electrically connecting the second turbo-generator 200 to the second synchronizer 214. The second converter 216 is configured to receive electrical power from the second turbo-generator 200, converts electrical power from alternating current (AC) to DC electrical power, and transfers DC electrical power to the second synchronizer 214. Thus, the second converter 216 may be an AC-DC converter 218 that is configured to convert AC electrical power received from the second turbo-generator 200 to DC electrical power. In such a case, the second synchronizer 214 may be a DC-DC converter 220, and modulates/changes a voltage of electrical power received from the second turbo-generator 200, and transfers modulated electrical power to the electrical bus 134.

Additionally, or optionally, the energy recovery system 170 may further include an outlet conduit 222 coupled to the first conduit 202, and a valve 224 that is coupled to the outlet conduit 222. The valve 224 may be operated to allow a flow of exhaust gases from the first conduit 202 to the ambient via the outlet conduit 222. Therefore, the valve 224 may be controlled to allow the exhaust gases flowing into the first conduit 202 to bypass the second turbo-generator 200, and flow through the outlet conduit 222. In an embodiment, the valve 224 may be actuated to allow a passage of the exhaust gases through the outlet conduit 222 to the ambient when the second turbo-generator 200 may be operating at full capacity. In an embodiment, the outlet conduit 222 may be coupled to second conduit 204.

The controller 190 may be in electrical communication with the turbocharger 154, the first turbo-generator 174, the second turbo-generator 200, the engine 118, the generator 130, the electrical bus 134, the first synchronizer 176, the second synchronizer 214, the bypass valve 186, the valve 224, and other components of the power system 104. The controller 190 may also be in electrical communication with the traction motors 112 and the auxiliary loads 122 of the machine 100. In an implementation, the controller 190 may receive information about one or more engine parameters, such as the engine load, engine power, engine speed, intake manifold pressures etc., from the engine 118. Further, the controller 190 may determine one or more operating conditions, such as speed, of the turbocharger 154, the first turbo-generator 174, and the second turbo-generator 200. Furthermore, the controller 190 may determine pressure of exhaust gases flowing through the exhaust conduit 152, the bypass conduit 172, the first conduit 202, and the second conduit 204. To enable such a function, energy recovery system 170 may include one or more sensors, in electrical communication with the controller 190, mounted in each of the exhaust conduit 152, the bypass conduit 172, the first conduit 202, and the second conduit 204. In certain other implementation, the controller 190 may receive information regarding amount of opening of the bypass valve 186 and the valve 224.

The controller 190 may control the bypass valve 186 and/or the valve 224 based on the information received from one or more of the engine 118, the turbocharger 154, the first turbo-generator 174, the second turbo-generator 200, etc. The controller 190 may also control the engine 118 based on electrical power generated by the first turbo-generator 174 or the second turbo-generator 200 or the sum of electrical power generated by the first turbo-generator 174 and the second turbo-generator 200. Further, the controller 190 may be configured to control the first turbine 156 of the turbocharger 154 such that a pressure of exhaust gases at a discharge of the first turbine 156 may be maintained at a pressure above a first threshold. Similarly, the controller 190 may control the second turbine 180 of the first turbo-generator 174 such that a pressure of exhaust gases at a discharge of the second turbine 180 may be maintained at a pressure above a second threshold. The controller 190 may control the first turbine 156 and the second turbine 180 to maintain a pressure at an inlet of the third turbine 208 above a certain minimum value. In doing so, the controller 190 ensures a proper and/or optimum functioning of the second turbo-generator 200. In an embodiment, the controller 190 may be engine control module (ECM) of the engine system 116. Alternatively, the controller 190 may be an independent controller different than the ECM. In certain other implementations, the controller 190 may be a locomotive controller.

### INDUSTRIAL APPLICABILITY

An exemplary operation of the machine 100 is now explained. During operation, the engine 118 of the locomotive 102 produces power to propel the machine 100, and also provide power to operate various auxiliary functions of the machine 100. During such operation, the controller 190 may monitor the engine parameters such as the engine load, the engine power, the engine speed etc. Based on the engine parameters, the controller 190 may control a flow of exhaust gases flowing through the bypass conduit 172 to recover energy from exhaust gases. For example, the controller 190 may determine the engine power that the engine 118 is producing, and compares the engine power to a predefined threshold. The controller 190 may actuate the bypass valve 186 to allow a portion of exhaust gases flowing into the exhaust conduit 152 to enter the bypass conduit 172 when the engine power is higher than the predefine threshold. The controller 190 may control a degree of opening of the bypass valve 186 based on the engine power and the predefined threshold.

In certain implementations, the controller 190 may determine an amount of the exhaust gases required to operate the turbocharger 154 to fulfill a demand of intake air from the engine 118. In certain scenario, an amount of the exhaust gases discharged by the engine 118 and flowing through the exhaust conduit 152 may exceed the amount of exhaust gases required to operate the turbocharger 154 to fulfill a demand of the intake air from the engine 118. Alternatively, the controller 190 may determine that the turbocharger 154 is operating at maximum capacity. In such cases, the controller 190 may actuate the bypass valve 186 to allow a portion of exhaust gases to bypass the turbocharger 154 and flow to the first turbo-generator 174 via the bypass conduit 172.

Exhaust gases diverted from the exhaust conduit 152 to the first turbo-generator 174, by actuating the bypass valve 186, drives the second turbine 180, which in turn drives the second generator 182 to produce electrical power in the form of AC electrical power. One or more parameters of electrical power received from the first turbo-generator 174 is modulated by the first synchronizer 176, and thereafter transmitted to the electrical bus 134 by the first synchronizer 176. The first synchronizer 176 modulates the one or more parameter of electrical power received from first turbo-generator 174 such that the one or more parameters of modulated electrical power are in sync with the one or more parameters of electrical power present on the electrical bus 134. To this end, the controller 190 may gather/detect an information about the one or more parameters of electrical power present/existing on the electrical bus 134. For example, the controller 190 may determine one or more of a voltage, a frequency, a current, a phase angle, etc. of electrical power present on the electrical bus 134.

For example, in the illustrated implementation, electrical power present on the electrical bus 134 may be DC electrical power. In such a case, the controller 190, for example, may determine a value of voltage of electrical power on the electrical bus 134. Based on the determined voltage, the controller 190 may control the first synchronizer 176 to modulate a voltage of electrical power received from the first turbo-generator 174 to a value equal to the determined voltage. In certain embodiments, as shown in FIG. 2 and FIG. 3, the first converter 192 converts AC electrical power received from the first turbo-generator 174 into DC electrical power before transmitting electrical power generated by the first turbo-generator 174 to the first synchronizer 176.

In certain implementations, the electrical bus 134 may receive AC electrical power from the generator 130 (traction alternator 140 or companion alternator 142). In such implementations, the first converter 192 may be omitted, and the controller 190, for example, may determine a voltage, a frequency, and a phase angle of electrical power present on the electrical bus 134. Based on the determined voltage, the determined frequency, and the determined phase angle, the controller 190 may control the first synchronizer 176 to modulate the voltage, the frequency, and the phase angle of electrical power received from the first turbo-generator 174 to a value equal to the determined voltage, the determined frequency, and the determined phase angle. In this manner, an energy from the exhaust gases is recovered by operating the first turbo-generator 174.

To recover additional energy from exhaust gases, the second turbo-generator 200 may be driven by the exhaust gases discharged from both the turbocharger 154 and the first turbo-generator 174. To facilitate recovery of the additional energy from exhaust gases, the controller 190 may control an operation of the turbocharger 154 and the first turbo-generator 174 based on the pressure of exhaust gases at the inlet of the third turbine 208, and therefore the second turbo-t generator 200. To do so, the controller 190 may control a speed of the first turbine 156 and the second turbine 180 to ensure the pressure of exhaust gases received by the second turbo-generator 200 is above a predefined threshold. By doing so, the controller 190 may ensure that the operation of the second turbo-generator 200 results in an energy recovery from the exhaust gases discharged by the engine 118.

The second turbo-generator 200 generates/produces electrical power in the form of AC electrical power upon being driven by exhaust gases discharged from the turbocharger 154 and the first turbo-generator 174. Similar to electrical power generated by the first turbo-generator 174, electrical power generated by the second turbo-generator 200 may be transmitted/transferred to the electrical bus 134 via the second synchronizer 214. One or more parameters of electrical power received from the second turbo-generator 200 is modulated by the second synchronizer 214, and thereafter transmitted/transferred to the electrical bus 134 by the second synchronizer 214. The second synchronizer 214 may modulate the one or more parameter of electrical power received from second turbo-generator 200 such that the one or more parameters of modulated electric power are in sync with the one or more parameters of electrical power present on the electrical bus 134. To this end, the controller 190 may gather/detect an information about the one or more parameters of electrical power present/existing on the electrical bus 134. For example, the controller 190 may determine one or more of a voltage, a frequency, a current, a phase angle, etc., of electrical power present on the electrical bus 134.

In certain implementations, electrical power present on the electrical bus 134 may be DC electrical power. In such a case, the controller 190, for example, may determine a value of a voltage of electrical power on the electrical bus 134. Based on the determined voltage, the controller 190 may control the second synchronizer 214 to modulate the voltage of electrical power received from the second turbo-generator 200 to a value equal to the determined voltage. In certain embodiments, as shown in FIG. 2 and FIG. 3, the second converter 216 converts AC electrical power into DC electrical power before transmitting electrical power generated by the second turbo-generator 200 to the second synchronizer 214.

In certain implementations, the electrical bus 134 may receive AC electrical power from the generator 130 (traction alternator 140 or companion alternator 142). In such implementations, the second converter 216 may be omitted, and the controller 190, in an example, may determine a voltage, a frequency, and a phase angle of electrical power present on the electrical bus 134. Based on the determined voltage, the determined frequency, and the determined phase angle, the controller 190 may control the second synchronizer 214 to modulate the voltage, the frequency, and the phase angle of electrical power received from the second turbo-generator 200 to a value equal to the determined voltage, the determined frequency, and the determined phase angle. In this manner, additional energy is recovered from the exhaust gases discharged by the engine 118 by operating the second turbo-generator 200.

Further, the controller 190 may control the engine 118 based on total electrical power generated by the first turbo-generator 174 and the second turbo-generator 200. In certain implementations, the controller 190 may reduce an engine power to reduce electrical power generated by the generator 130 (traction alternator 140 or companion alternator 142) by an amount corresponding to the total electrical power generated by the first turbo-generator 174 and the second turbo-generator 200. For so doing, in an implementation, the controller 190 may reduce an amount of fuel injected into the engine 118. In an exemplary embodiment, it may be contemplated that engine 118 may be producing 150 MW of power to meet the one or more loads 120 of the machine 100. The energy recovery system 170 may produce 5 MW of electrical power using exhaust gases discharged by the engine 118. Therefore, the controller 190 may control the engine 118 such that engine 118 may now produce 145. 5 MW of power and rest 4.5 MW of electrical power is generated by the energy recovery system 170 (the first turbo-generator 174 and/or the second turbo-generator 200) by recovering energy from exhaust gases discharged by the engine 118. In doing so, a total consumption of fuel by the engine 118 and hence the machine 100 reduces. Also, electrical power generated by the energy recovery system 170 (the first turbo-generator 174 and/or the second turbo-generator 200) is directly provided to the electrical bus 134 without intermittently storing the generated electrical power into a power storage unit such as a battery. In this manner, the energy recovery system 170 and thus the power system 104 reduces losses of electrical power associated with the storage of electrical power.

What is claimed is:

1. An energy recovery system for a power system, the power system includes an engine, a generator driven by the engine to produce electrical power, an electrical bus configured to receive electrical power from the generator, an exhaust conduit configured to receive exhaust gases discharged from the engine, and a turbocharger coupled to the exhaust conduit to receive exhaust gases from the engine and configured to provide compressed air to the engine, the energy recovery system comprising:
a bypass conduit coupled to the exhaust conduit upstream of the turbocharger, the bypass conduit facilitates a portion of exhaust gases from the exhaust conduit to bypass the turbocharger;
a turbo-generator coupled to the bypass conduit, the turbo-generator being driven by the portion of exhaust gases bypassing the turbocharger to generate electrical power; and
a synchronizer electrically coupled to the turbo-generator and the electrical bus, the synchronizer configured to modulate one or more parameters of electrical power received from the turbo-generator based on one or more parameters of electrical power present on the electrical bus, wherein the synchronizer transmits modulated electrical power to the electrical bus.

2. The energy recovery system of claim 1 further including a converter electrically connecting the turbo-generator to the synchronizer and configured to convert alternating current (AC) electrical power received from the turbo-generator to direct current (DC) electrical power and transmit DC electrical power to the synchronizer.

3. The energy recovery system of claim 2, wherein the synchronizer is a DC-DC converter configured to modulate a voltage of electrical power received from the converter based on a voltage of electrical power present on the electrical bus.

4. The energy recovery system of claim 1, wherein the one or more parameters of electrical power received from the turbo-generator includes at least one of a voltage, a current, or a frequency.

5. The energy recovery system of claim 1 further including a bypass valve for controlling an amount of exhaust gases passing through the bypass conduit.

6. The energy recovery system of claim 5, wherein the bypass valve is controlled based on one or more engine parameters.

7. The energy recovery system of claim 1, wherein the turbo-generator is a first turbo-generator, and the energy recovery system further includes a second turbo-generator configured to be driven by exhaust gases released from the turbocharger and the first turbo-generator to generate electrical power that is transmitted to the electrical bus.

8. A power system comprising:
an engine;
a generator driven by the engine to produce electrical power;
an electrical bus configured to receive electrical power from the generator and provides electrical power to one or more loads;
an exhaust conduit configured to receive exhaust gases discharged from the engine;
a turbocharger coupled to the exhaust conduit to receive exhaust gases from the engine and configured to provide compressed air to the engine;
a bypass conduit coupled to the exhaust conduit upstream of the turbocharger, the bypass conduit facilitates a portion of exhaust gases from the exhaust conduit to bypass the turbocharger;
a turbo-generator coupled to the bypass conduit, the turbo-generator being driven by the portion of exhaust gases bypassing the turbocharger to generate electrical power; and
a synchronizer electrically coupled to the turbo-generator and the electrical bus, the synchronizer configured to modulate one or more parameters of electrical power received from the turbo-generator based on one or more parameters of electrical power present on the electrical bus, wherein the synchronizer transmits modulated electrical power to the electrical bus.

9. The power system of claim 8 further including a converter electrically connecting the turbo-generator to the synchronizer and configured to convert alternating current (AC) electrical power received from the turbo-generator to direct current (DC) electrical power and transmit DC electrical power to the synchronizer.

10. The power system of claim 9, wherein the synchronizer is a DC-DC converter configured to modulate a voltage of electrical power received from the converter based on a voltage of electrical power present on the electrical bus.

11. The power system of claim 8, wherein the one or more parameters of electrical power received from the turbo-generator includes at least one of a voltage, a current, or a frequency.

12. The power system of claim 8 further including a bypass valve for controlling an amount of exhaust gases passing through the bypass conduit.

13. The power system of claim 12, wherein the bypass valve is controlled based on one or more engine parameters.

14. The power system of claim 8, wherein the turbo-generator is a first turbo-generator, and the power system further includes a second turbo-generator configured to be driven by exhaust gases released from the turbocharger and the first turbo-generator to generate electrical power that is transmitted to the electrical bus.

15. A locomotive comprising:
an engine;
a generator driven by the engine to produce electrical power;
an electrical bus configured to receive electrical power from the generator,
one or more loads configured to receive electrical power from the electrical bus;
an exhaust conduit configured to receive exhaust gases discharged from the engine;
a turbocharger coupled to the exhaust conduit to receive exhaust gases from the engine and configured to provide compressed air to the engine;
a bypass conduit coupled to the exhaust conduit upstream of the turbocharger, the bypass conduit facilitates a portion of exhaust gases from the exhaust conduit to bypass the turbocharger;
a turbo-generator coupled to the bypass conduit, the turbo-generator being driven by the portion of exhaust gases bypassing the turbocharger to generate electrical power; and
a synchronizer electrically coupled to the turbo-generator and the electrical bus, the synchronizer configured to modulate one or more parameters of electrical power received from the turbo-generator based on one or more parameters of electrical power present on the electrical bus, wherein the synchronizer transmits modulated electrical power to the electrical bus.

16. The locomotive of claim 15 further including a converter electrically connecting the turbo-generator to the synchronizer and configured to convert alternating current (AC) electrical power received from the turbo-generator to direct current (DC) electrical power and transmit DC electrical power to the synchronizer.

17. The locomotive of claim 16, wherein the synchronizer is a DC-DC converter configured to modulate a voltage of electrical power received from the converter based on a voltage of electrical power present on the electrical bus.

18. The locomotive of claim 15, wherein the one or more parameters of electrical power received from the turbo-generator includes at least one of a voltage, a current, or a frequency.

19. The locomotive of claim 15, wherein the generator is a traction alternator and the one or more loads include one or more traction motors of the locomotive.

20. The locomotive of claim 15, wherein the generator is a companion alternator and the one or more loads include one or more auxiliary loads of the locomotive.
